(19) United States
(12) Patent Application Publication
(10) Pub. No.: US 2012/0020818 A1
(43) Pub. Date: Jan. 26, 2012

(54) AIR COMPRESSOR STRUCTURE FOR PAINT SPRAYING

(76) Inventor: Peter Chen, Taipei (TW)

(21) Appl. No.: 12/839,745

(22) Filed: Jul. 20, 2010

(51) Int. Cl. F04B 35/00; B05B 9/01

(52) U.S. Cl. 417/410.1; 239/526

(57) ABSTRACT

An air compressor structure for paint spraying includes: a housing having an internal receiving space; an envelope body mated with the housing and having an internal chamber and an outlet in communication with the chamber; a magnetization unit disposed in the receiving space, the magnetization unit including a main body and at least one magnetic member disposed on the main body, the main body having a first end and a second end, a first winding assembly and a second winding assembly being respectively positioned on two sides of the magnetic member; and a first membrane and a second membrane disposed in the receiving space and arranged beside the first and second ends of the magnetization unit. The magnetization unit can reciprocally drive the first and second membranes to vibrate and produce compressed air. The compressed air is output and directly supplied to a paint spray gun for paint spraying operation.

### FIELD OF THE INVENTION

The present invention relates to an improved air compressor structure applicable to paint spraying, and more particularly to an air compressor structure having the advantages of low noise and low power consumption.

### BACKGROUND OF THE INVENTION

In modern lives, environmental protection and efficiency are more and more emphasized. Almost all business runners try hard to improve working efficiency and promote environment quality, especially to improve the problem of environmental noise. Following the rapid advance of various technologies in different fields, more and more new products are available in the market. While enjoying the convenience brought by these new products, people at the same time suffer from some problems accompanying the development of these new products, such as noise problem. For example, airplanes, automobiles and mechanical tools always make noise. People can hardly concentrate their attention on their work in a noisy environment so that the working efficiency will be inevitably lowered. Moreover, the noise is harmful to human health and will threaten the safety of people. For example, in a noisy environment, a person can hardly hear from the external side. In this case, the person may have tinnitus to cause an accident. Therefore, it has become an important issue in various fields to promote working efficiency and improve environment quality.

A conventional air compressor is a highly noisy device. The most effective measure for controlling the noise is to control the sound source. According to the property, the noise can be divided into two types, that is, mechanical structural noise and aerodynamic noise. Almost all parts of the air compressor will make noise in operation. The intensity and frequency of the noise vary with the parts that make noise. In general, the inlet and outlet of the air compressor are in direct communication with the atmosphere. Therefore, the noise made at the inlet and outlet of the air compressor is often 5˜10 dB(A) higher than the noise made by the main sound sources of the other parts. Therefore, the noise made at the inlet and outlet of the air compressor is the major part of the total noise of the air compressor. The outlet of the air compressor must be connected to an inlet pipe of a pneumatic tool to provide compressed air for the pneumatic tool. However, when the high-pressure air is exhausted from the pneumatic tool, an ear-piercing sound is made by the pneumatic tool. Therefore, both the air compressor and the pneumatic tool will emit great noise in intake and exhaustion operation. In a conventional high-speed carbon-brush motor air compressor, the lifetime of the carbon brush is only 2000 hours. The conventional induction motor air compressor has a lifetime longer than that of the carbon-brush motor air compressor. However, the induction motor operates at lower speed and has a larger volume and higher power consumption.

Furthermore, in a common air compressor, the compressed air is reserved in an air reservoir in a high-pressure state. In use, the high-pressure air is output from the air reservoir. In paint spraying operation, the air compressor is connected to a paint spray gun to supply compressed air to the paint spray gun for spraying the paint. However, the compressed air has a considerably great pressure and will make an extremely great noise when exhausted. Moreover, it is hard to control the amount of the paint that is sprayed with the high-pressure air. Therefore, only part of the sprayed paint will adhere to the work piece to be coated, while much redundant paint is wasted. In addition, the redundant paint that fails to adhere to the work piece will spread in the air. In the case that the paint is inhaled into human body, the paint will affect the health of people. According to the aforesaid, the conventional air compressor has the following shortcomings:
1. Great noise.
2. It is hard to control the amount of the paint that is sprayed with the high-pressure air.
3. The lifetime is shorter and the power consumption is higher.
4. The redundant paint will spread in the air to affect the health of people.

### SUMMARY OF THE INVENTION

A primary object of the present invention is to provide an improved air compressor structure for paint spraying, which has the advantage of lower noise.

A further object of the present invention is to provide the above air compressor structure for paint spraying, which has the advantage of lower power consumption and smaller amount of wasted paint.

To achieve the above and other objects, the air compressor structure for paint spraying of the present invention is connectable to a paint spray gun. The air compressor structure includes a housing, an envelope body, a magnetization unit, a first membrane and a second membrane. The housing has an internal receiving space. The envelope body has an internal chamber and an outlet in communication with the chamber. The magnetization unit is disposed in the receiving space. The magnetization unit includes a main body and at least one magnetic member disposed on the main body. The main body has a first end and a second end. A first winding assembly and a second winding assembly are respectively correspondingly positioned on two sides of the magnetic member. The first membrane is disposed in the receiving space and correspondingly arranged beside the first end of the magnetization unit. The second membrane is disposed in the receiving space and correspondingly arranged beside the second end of the magnetization unit. When current flows through the first and second winding assemblies, the first and second winding assemblies are magnetized to apply a magnetic force to the magnetization unit and make the magnetization unit reciprocally move. At this time, the first and second ends of the magnetization unit respectively reciprocally drive the first and second membranes to vibrate and produce compressed air. The compressed air is output and directly supplied to the paint spray gun for paint spraying operation so that the noise made by the air compressor is reduced. Moreover, the air compressor will output the compressed air at an appropriate pressure without wasting any paint material. Therefore, only little redundant paint will spread in the air. This meets the requirement of environmental protection and also prevents the paint from being inhaled into human body to cause poisoning.

According to the aforesaid, the present invention has the following advantages:
1. Lower noise.
2. The amount of wasted paint is minimized.
3. Only little redundant paint will spread in the air so that the air pollution is minimized.

### BRIEF DESCRIPTION OF THE DRAWINGS

The structure and the technical means adopted by the present invention to achieve the above and other objects can be best understood by referring to the following detailed description of the preferred embodiment and the accompanying drawings, wherein:

FIG. 1 is a perspective exploded view of the air compressor structure for paint spraying of the present invention;

FIG. 2 is a perspective assembled view of the air compressor structure for paint spraying of the present invention;

FIG. 3 is a sectional assembled view of the air compressor structure for paint spraying of the present invention; and

FIG. 4 shows the operation of the air compressor structure for paint spraying of the present invention.

### DETAILED DESCRIPTION OF THE PREFERRED EMBODIMENT

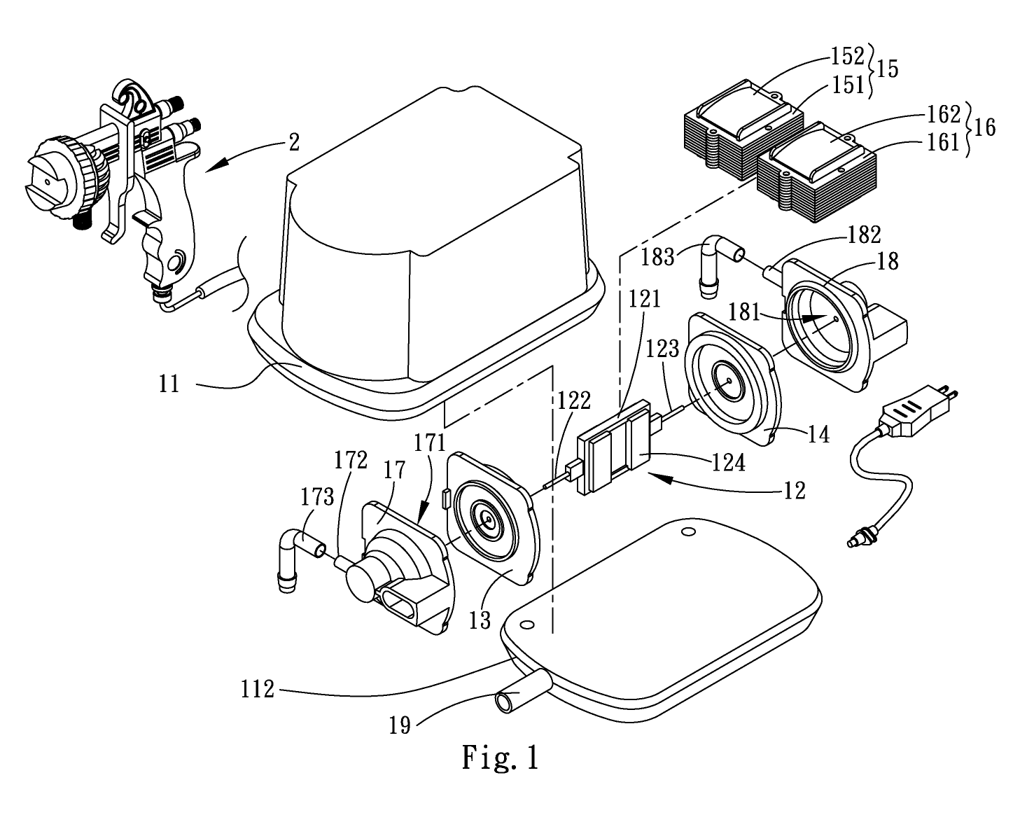

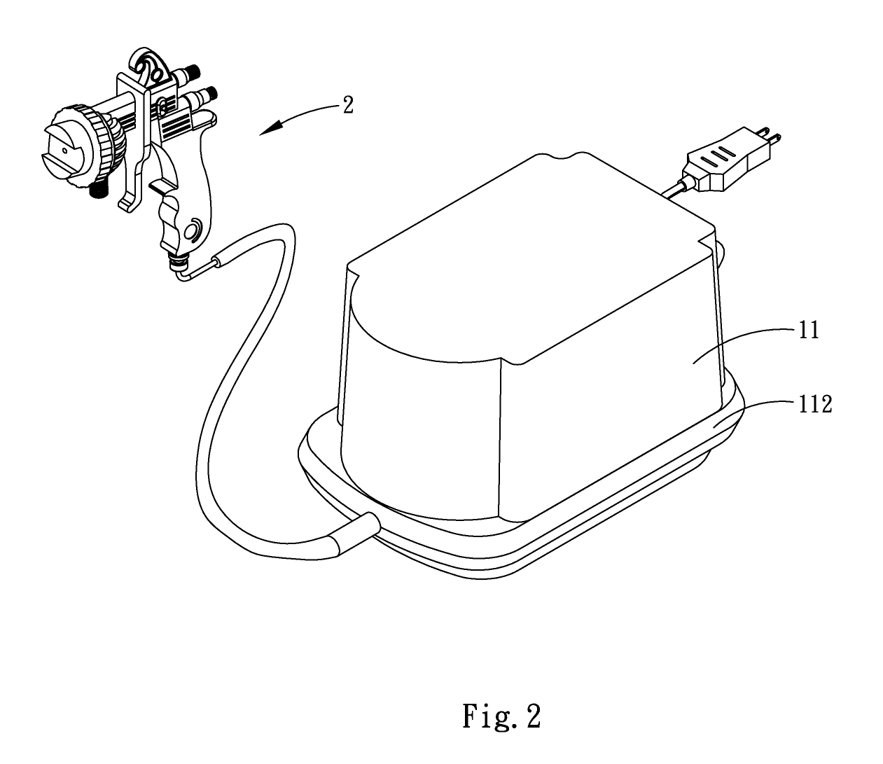

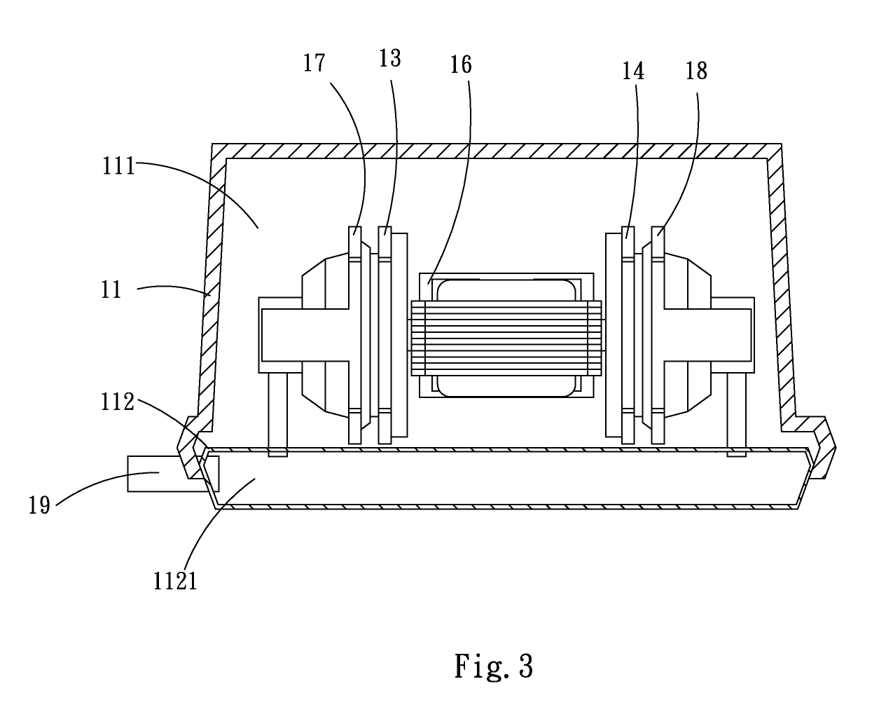

Please refer to FIGS. 1, 2 and 3. FIG. 1 is a perspective exploded view of the air compressor structure for paint spraying of the present invention. FIG. 2 is a perspective assembled view of the air compressor structure for paint spraying of the present invention. FIG. 3 is a sectional assembled view of the air compressor structure for paint spraying of the present invention. The air compressor structure for paint spraying of the present invention is connectable to a paint spray gun 2, including a housing 11, an envelope body 112, a magnetization unit 12, a first membrane 13 and a second membrane 14.

The housing 11 is mated with the envelope body 112 to cover the envelope body 112, whereby the housing 11 and the envelope body 112 together define a receiving space 111. The envelope body 112 has an internal chamber 1121 and an outlet 19 in communication with the chamber 1121.

The magnetization unit 12 is disposed in the receiving space 111. The magnetization unit 12 includes a main body 121 and at least one magnetic member 124. The main body 121 has a first end 122 and a second end 123. The magnetic member 124 is arranged on one side of the main body 121. A first winding assembly 15 and a second winding assembly 16 are respectively correspondingly positioned on two sides of the magnetic member 124.

The first winding assembly 15 has multiple silicon steel sheets 151 and multiple windings 152 wound around the silicon steel sheets 151.

The second winding assembly 16 has multiple silicon steel sheets 161 and multiple windings 162 wound around the silicon steel sheets 161.

The first and second membranes 13, 14 are disposed in the receiving space 111.

The first membrane 13 is correspondingly arranged beside the first end 122 of the magnetization unit 12. The second membrane 14 is correspondingly arranged beside the second end 123 of the magnetization unit 12.

A first side cover 17 is mated with one side of the first membrane 13, which side is distal from the magnetization unit 12. The first side cover 17 has a first flow way 171 in communication with the first membrane 13 and connected to a first opening 172. At least one first pipe 173 is mated with the first opening 172.

A second side cover 18 is mated with one side of the second membrane 14, which side is distal from the magnetization unit 12. The second side cover 18 has a second flow way 181 in communication with the second membrane 14 and connected to a second opening 182. At least one second pipe 183 is mated with the second opening 182.

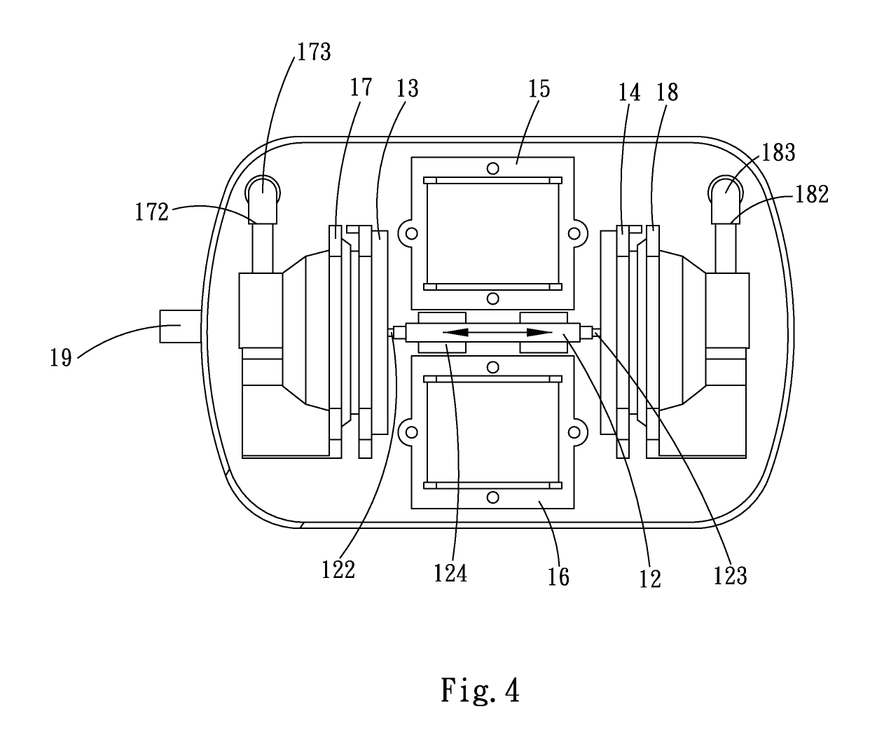

Please refer to FIG. 4, which shows the operation of the air compressor structure for paint spraying of the present invention. The first pipe 173 is mated with the first opening 172 of the first side cover 17. One side of the first side cover 17 is mated with the first membrane 13. The second pipe 183 is mated with the second opening 182 of the second side cover 18. One side of the second side cover 18 is mated with the second membrane 14. The first side cover 17 and the first membrane 13, and the second side cover 18 and the second membrane 14 are respectively disposed at the first and second ends 122, 123 of the magnetization unit 12. The first and second winding assemblies 15, 16 are correspondingly disposed on two sides of the magnetic member 124 of the magnetization unit 12. When current flows through the first and second winding assemblies 15, 16, the first and second winding assemblies 15, 16 are magnetized to apply a magnetic force to the magnetization unit 12 and make the magnetization unit 12 reciprocally move. At this time, the first and second ends 122, 123 of the magnetization unit 12 respectively reciprocally drive the first and second membranes 13, 14 to vibrate and produce compressed air. The compressed air is transferred through the first and second openings 172, 182 of the first and second side covers 17, 18 into the chamber 1121 of the envelope body 112 (as shown in FIG. 3).

The first and second pipes 173, 183 are respectively connected to the first and second openings 172, 182. Accordingly, the first and second pipes 173, 183 serve to guide the compressed air into the chamber 1121 of the envelope body 112 (as shown in FIG. 3). The outlet 19 of the envelope body 112 is connected to the paint spray gun 2 (as shown in FIG. 2). Accordingly, the compressed air is output from the outlet 19 and supplied to the paint spray gun 2 (as shown in FIG. 2) for paint spraying operation.

The present invention is different from the prior art in that when the first and second winding assemblies 15, 16 are magnetized, a magnetic force is applied to the magnetization unit 12 to make the magnetization unit 12 reciprocally move. At this time, the magnetization unit 12 reciprocally drives the first and second membranes 13, 14 to vibrate and produce compressed air. The compressed air can be directly used without being first reserved in an air reservoir. The compressed air is output and directly supplied to the paint spray gun 2 for paint spraying operation. The compressed air will have an appropriate pressure so that the paint spray gun will spray a suitable amount of paint onto the surface of a work piece. In this case, only little redundant paint will spread in the air. This meets the requirement of environmental protection and also prevents the paint from being inhaled into human body to cause poisoning. Moreover, the present invention has the advantages of lower noise and lower energy consumption over the prior art.

The above embodiment is only used to illustrate the present invention, not intended to limit the scope thereof. It is understood that many changes and modifications of the above embodiment can be made without departing from the spirit of the present invention. The scope of the present invention is limited only by the appended claims.

What is claimed is:

1. An air compressor structure for paint spraying, the air compressor structure being connectable to a paint spray gun, the air compressor structure comprising:
a housing having an internal receiving space;
an envelope body, the housing being mated with the envelope body to cover the envelope body, the envelope body having an internal chamber and an outlet in communication with the chamber;
a magnetization unit disposed in the receiving space, the magnetization unit including a main body and at least one magnetic member disposed on the main body, the main body having a first end and a second end, a first winding assembly and a second winding assembly being respectively correspondingly positioned on two sides of the magnetic member;
a first membrane disposed in the receiving space and correspondingly arranged beside the first end of the magnetization unit; and
a second membrane disposed in the receiving space and correspondingly arranged beside the second end of the magnetization unit.

2. The air compressor structure for paint spraying as claimed in claim 1, wherein the first winding assembly has multiple silicon steel sheets and multiple windings wound around the silicon steel sheets.

3. The air compressor structure for paint spraying as claimed in claim 1, wherein the second winding assembly has multiple silicon steel sheets and multiple windings wound around the silicon steel sheets.

4. The air compressor structure for paint spraying as claimed in claim 1, wherein a first side cover is mated with one side of the first membrane, which side is distal from the magnetization unit, the first side cover having a first flow way in communication with the first membrane and connected to a first opening, at least one first pipe being mated with the first opening.

5. The air compressor structure for paint spraying as claimed in claim 1, wherein a second side cover is mated with one side of the second membrane, which side is distal from the magnetization unit, the second side cover having a second flow way in communication with the second membrane and connected to a second opening, at least one second pipe being mated with the second opening.
